(19) United States
(12) Patent Application Publication
(10) Pub. No.: US 2025/0334783 A1
(43) Pub. Date: Oct. 30, 2025

(54) DIFFUSER ROD

(71) Applicant: BARCO N.V., Kortrijk (BE)

(72) Inventor: Terje Olaf ANTONSEN, VESTRØY (NO)

(73) Assignee: BARCO N.V., Kortrijk (BE)

(21) Appl. No.: 19/128,377

(22) PCT Filed: Nov. 13, 2023
(86) PCT No.: PCT/EP2023/081647

§ 371 Date: May 8, 2025

(30) Foreign Application Priority Data
Nov. 11, 2022 (LU) LU103034

(51) Int. Cl. G02B 19/00; G03B 21/20

(52) U.S. Cl. CPC G02B 19/0019; G02B 19/0057; G03B 21/204; G03B 21/208

(57) ABSTRACT

There is provided an optical assembly for homogenizing a light beam and optimizing the wavelength conversion efficiency of an illumination system, the optical assembly being configured to be positioned in a beam path of the illumination system comprising a light source emitting the light beam, the optical assembly comprising a wavelength conversion element, a lens assembly comprising at least one lens for focusing the light beam on the wavelength conversion element an integrator rod comprising an entrance and an exit plane, wherein the exit plane of the integrator rod is configured to be reimaged on the wavelength conversion element via the lens assembly, wherein the surface of the exit plane of the integrator rod is a diffusing surface having an engineered topology optimized for the illumination system and with reduced thermal saturation and quenching limits.

### TECHNICAL FIELD

The present disclosure relates to optical assemblies for homogenizing a light beam and optimizing the wavelength conversion efficiency of an illumination system, and illumination systems comprising the same.

### BACKGROUND

To produce high brightness from a projector, a laser/phosphor based light source is a common and economically attractive go-to solution. The ceramic, or resin-based phosphor is often chosen based on its coverage of green and red wavelength ranges, and its conversion efficiency. The phosphor is photochemically activated by high power input of blue laser light. The generated yellow phosphor light, together with a secondary channel of diffused blue laser light, creates neutral or near-neutral white light. From the white light, all colours needed can be separated later in the system to create accurate imagery.

On the product level, typical targets are low weight, small size, highest possible brightness, with coverage of a certain colour gamut and white point. A minimum of brightness decay (due to optical degradation or aging of lasers), and low risk of failures are always desired. Often there are incremental improvements from suppliers (like lasers increasing in output power), and it is therefore desirable to have enough margin of failure on optical components to be able to withstand some incremental gains.

A design choice to be made is between single or multiple light source channels. There is always a significant physically determined light loss by combining a plurality of light sources, while space requirements also increase with each added light source. The phosphor conversion efficiency is highly dependent on a system's ability to keep temperatures low with different cooling solutions and with the phosphor mounted on wheels rotating at high speed.

Considering cost and space-efficient cooling solutions that are easily available, it can be beneficial for brightness decay, safety margin and phosphor assembly size that the laser power towards the phosphor is distributed between channels.

With the choice of a single channel light source, considering equal brightness target, a more compact, light-weight solution can be achieved, but the phosphor cooling must be scaled up, and each optical component in the light path is subject to higher stress, and thus affecting brightness decay and margin for component failures.

WO 2012/139634 discusses a light source apparatus designed to address speckle interference patterns in projection systems. It proposes a two-stage integrating system involving a second integrating element, such as a diffuser or fly-eye integrator, to optimize speckle reduction. The challenge lies in achieving this reduction when using different wavelengths, and the invention aims to balance speckle reduction, angular separation, and optical efficiency. The apparatus is intended for use in projection systems, providing even intensity distribution for a light modulator illuminated by laser sources with various wavelengths. However, WO2012139634 only addresses problems related to speckles (spatial homogeneity).

The application of diffusers for speckle reduction proves practical exclusively for direct laser light. Once the laser light undergoes conversion and is emitted by the phosphor, the inherent coherence causing speckle is entirely disrupted. The emission transforms into quasi-Lambertian, characterized by extensive angular mixing and a significantly broadened spectrum, resulting in complete wavelength mixing.

In many projector scenarios where this innovation finds application, a portion of the blue light is retained as laser light without undergoing phosphor conversion. In such cases, the introduction of diffusers aids in despeckling. Additionally, in instances where an auxiliary laser illumination, such as additional red lasers, is employed atop the phosphor-converted light, these lasers benefit from supplementary despeckling.

It is noteworthy that the phosphor-converted light itself, post-conversion, is inherently devoid of speckle and does not necessitate further despeckling interventions.

Traditionally, the primary homogenization focus resides in the “spatial” domain, driven by various considerations, with a predominant emphasis on equalizing power load, denoted as W/m².

In a laser-phosphor based projector, the laser beams are highly directional, and very high in radiance. Besides safety aspects, the beams need to be homogenized to distribute the power load in optics and wavelength conversion elements, in order to avoid deterioration and breakage, but for the wavelength conversion element specifically, the impinging spot needs to be as uniformly spread, and within an optimally scaled and optimally shaped two-dimensional image in order to be as efficient as possible.

Well known methods to achieve a good uniformization by splitting and randomizing rays, is the use of diffusers and integrating prisms/rods, preferably in combination. Integrating rods make use of the total internal reflection effect (ref. Snell's law), and relies on the angular difference between incoming rays, as the number of reflections internally will vary, creating higher order imaging between image planes.

The full width half maximum of the diffuser needs to be carefully selected to obtain the desired results. Such diffusers are available off the shelf and diffusers with various degrees of diffusion can therefore easily be tested and selected.

The dimensions of the light rod are optimized to achieve the required beam uniformity. The entrance and exit surfaces of the light rod need to be flat and have an anti-reflection coating.

In a laser/phosphor projector, the exit plane of the light rod is re-imaged on the wavelength conversion element. In high power systems, these are usually placed on a spinning wheel to be able to handle the temperature and power load.

Diffusers in projectors are used to reshape the angular and positional distribution of light downstream from the diffusing surface, or to break up laser speckle.

However, high power laser projectors suffer from various problems.

It has been observed that lenses after the light rod have the tendency to crack due to heat or too high temperature difference within one element (delta temperature). The heat budget needs to be optimized, or positionally distributed in an optimal fashion. The use of glass with higher index is even more prone to crack.

However, a projector needs to be as compact and as light weight as possible. Using optical material with reduced refractive index would result in a bigger optical design and/or would require more lenses.

On the other hand, the optical power density of projectors and light canons tends to increase, to render bright images to the public. All optical components, and their usual thin film coating layers, have a breakage limit on incident power density, often expressed in W/cm2.

Even below the breakage limit, each element and coating have less than 100% transmission or reflection, which further deteriorates during usage, depending on wavelength, surface roughness and power level. There are many known damage mechanisms, but in optical design it is well known that it's always beneficial to use as few surfaces/components as possible.

There is thus a need to provide illumination systems such as projectors or light canons with increased initial product brightness but also with reduced optical degradation without increasing the optical design complexity and size of the illumination system.

### SUMMARY

There is therefore provided an optical assembly for homogenizing a light beam and optimizing the wavelength conversion efficiency in an illumination system, the optical assembly being configured to be positioned in a beam path of the illumination system comprising a light source emitting the light beam, the optical assembly comprising a wavelength conversion element, a lens assembly comprising at least one lens for focusing the light beam on the wavelength conversion element, an integrator rod comprising an entrance and an exit plane, wherein the exit plane of the integrator rod is configured to be reimaged on the wavelength conversion element via the lens assembly, and wherein the surface of the exit plane of the integrator rod is a diffusing surface.

The placement of the diffuser precisely at the exit of the rod is intended not only for achieving optimal power load equalization and smoothing in the spatial domain but also to enhance uniformity in the angular domain. While this may not directly impact the power load on the illumination spot of the phosphor, it effectively reduces power loads for all intermediate optical components situated between the exit of the light rod and the phosphor surface, notably the optical relay lenses.

The diffusing surface preferably has an engineered topology optimized for the illumination system and with reduced thermal saturation and quenching limits.

Providing a diffusing surface directly on the exit plane of the integrator rod eliminates an additional diffuser downstream of the integrator rod. This thereby eliminates an airgap, reduces complexity of assembly, reduces the risks during alignment, and also reduces the number of optical surfaces in the optical design. In addition, the thermal benefits are more than expected. In fact, the integrator rod can absorb more heat than a simple diffuser which has a reduced thickness compared to the integrator rod. Therefore, the coatings on the integrator rod have a longer lifetime, than those on separate diffusers. The fewer total number of surfaces compared to prior art solutions contribute to higher total system transmission, thus positively affecting product brightness, but also reducing the decay rate.

Additionally, in prior art solutions, it is not possible to have a perfectly focused image from the integrator rod exit plane onto a secondary image plane (i.e., the surface of a wavelength conversion element), which has proven to be beneficial to the conversion efficiency of the wavelength conversion element.

The spot on the phosphor is thereby as uniform as possible, thereby avoiding quenching on the phosphor. This prevents the creation of hot spots on the phosphor.

The angles of the light beam are sufficiently spread in order to avoid lens cracking.

In a conventional design, there is limited space for providing a diffuser after the integrator rod, as the optical design needs to stay as compact as possible. Therefore, providing the diffuser directly on the integrator rod provides many advantages.

To reduce the dimensions of an optical design, glass with high index is usually selected. However, such glass is also more prone to cracks. Less refractive materials requires the use of additional lenses, and therefore would result in a more stretched optical design.

Advantageously, the surface of the entrance plane of the integrator rod is a diffusing surface with an optimized profile and surface morphology. Preferably, the diffusing surface of the entrance plane preferably has an engineered topology optimized for the illumination system and with reduced thermal saturation and quenching limits.

Providing a second surface on the integrator rod which is a diffusing surface improves even more the optical design, as the light rod can be made shorter thanks to additional diffusing surface. A separate diffuser at the entrance of the integrator rod is also not necessary, thereby reducing the number of required surfaces. All the benefits mentioned above with one diffusing surface are increased with the second diffusing surface on the integrator rod.

Preferably, the light source is provided by at least one of a laser source emitting the light beam and a first focusing lens assembly for focusing the light beam, or a plurality of laser diodes.

Such light sources are optimal for use with the wavelength conversion filter.

Preferably, the integrator rod is a rectangular parallelepiped light pipe whose cross section at the exit plane is an aperture stop of the optical assembly.

Such rectangular parallelepiped light pipes are easy to manufacture and the cross section corresponds to the aperture.

Preferably, the cross section of the integrator rod is a polygon, such as a hexagon, a pentagon, an octagon, or a trapezoid.

Such more complex shapes increase the number of reflections inside the integrator rod, thereby providing a better uniformization of the beam.

Even more preferably, the edges of the integrator rod are tapered. This enables to reduce the angle distribution spread at the exit of the integrator rod, but without reducing the quantity of internal reflections. In fact, if the cross section of the integrator rod increases towards the exit plane, the effect is to reduce the angle distribution spread at the exit of the integrator rod.

Preferably, the diffuser profile is at least one of a Gaussian, Lambertian, top-hat engineered surface, and specific grading, such as a specific HWHM for a gaussian profile, with a specific grit (size of the grading).

The type of diffuser profile is an important parameter of the optical system, which is dependent on the overall optical design.

Depending on the optical design, the HWHM is preferably in the range of 0.5° to 8°, preferably 1° to 6°, more preferably 2° to 4°, and even more preferably 3°.

Preferably, the optimal HWHM (Half Width at Half Maximum) is determined through a weighted consideration comprising at least one of the following factors:
a) Phosphor spot peak irradiance, tailored to a specified phosphor wheel size and optimal cooling conditions, ensuring it remains maximized while staying below the phosphor saturation/quenching limit.
b) Total power retained through relay optics and directed onto the phosphor, optimized to achieve the highest level possible without surpassing the phosphor saturation/quenching limit.
c) Peak irradiance at the core of the weakest lens in the system downstream of the diffuser rod, minimized to the lowest achievable level.
d) Total resulting brightness output downstream of lens, optimized to attain the highest level possible.

This weighted determination ensures an optimal HWHM, balancing the key factors for enhanced performance and efficiency in the optical assembly.

Preferably, the diffuser profile is the same on the entrance and exit planes of the integrator rod.

Alternatively, the diffuser profile is different on the entrance and exit planes of the integrator rod.

Adjusting the diffuser profiles at the entrance and exit planes of the integrator rod can improve the optical efficiency of the illumination system, depending on the overall optical design.

Preferably, the surface of the exit plane and/or the entrance plane comprises an anti-reflection coating.

There is also provided an illumination system comprising the optical assembly described above.

Preferably, the illumination system is a projector.

Alternatively, the illumination system is a light canon.

In fact, the solution described in the present specification is extremely efficient in an illumination system which comprises a wavelength conversion element.

It is an advantage that the illumination system has a light source which is provided by at least one of
a laser source emitting the light beam and a first focusing lens assembly for focusing the light beam, or
a plurality of laser diodes.

It is to be understood that both the foregoing general description and the following detailed description are exemplary and are intended to provide further explanation of the invention as claimed. Other advantages and features of the invention will be apparent from the following description, drawings and claims.

### BRIEF DESCRIPTION OF DRAWINGS

These and other features, aspects, and advantages of the apparatus, systems and methods of the present disclosure will become better understood from the following description, appended claims, and accompanying drawing wherein:

FIG. 1 illustrates a 3 chip DLP projectors light source comprising two light source paths (diffused blue and laser to phosphor conversion path), a wavelength conversion wheel according to the state of the art.

FIG. 2A illustrates an optical assembly comprising a light rod and two diffusers upstream of the wavelength conversional element according to the state of the art.

FIG. 2B illustrates a diffuser with coating decay, according to the state of the art.

FIGS. 3A illustrates an exemplary schematic optical diagram of a laser/phosphor projector light source comprising a diffuser rod according to the invention.

FIG. 3B illustrates an example of a diffuser rod according to the invention.

FIG. 4A illustrates an exemplary 3D schematic optical diagram of a laser/phosphor projector light source comprising a diffuser rod according to the invention.

FIG. 4B is a magnification of a portion of FIG. 4A comprising the wavelength conversion element.

FIG. 5A is a schematic representation of an example of a diffuser rod.

FIG. 5B is an example of a topology of the diffusing surfaces of the diffuser rod illustrated in FIG. 5A.

FIG. 6A illustrates the power distribution in the mid lens plane of the laser focusing lens 405 of FIG. 4A

FIG. 6B illustrates the remaining power in a plane upstream of the first diffusing surface of the diffuser rod of FIG. 4A

FIG. 6C illustrates the remaining power in a plane located 1 mm inside the diffuser rod 415, downstream of the first entrance diffusing surface 415a of FIG. 4A.

FIG. 6D illustrates the power distribution in a plane 1 mm inside the diffuser rod, near and upstream of the exit plane 415b of FIG. 4A.

FIG. 6E illustrates the power distribution in a plane 1 mm downstream of the exit diffusing surface 415b in FIG. 4A.

FIGS. 6F and 6G illustrate a comparison of the peak irradiance in the focusing lens 435 without, then with the diffuser rod respectively.

FIGS. 7A and 7B illustrate the irradiance pattern on the wavelength conversion element, with the diffuser rod according to the present invention.

FIGS. 8A and 8B illustrate the irradiance pattern on the wavelength conversion element, with an integrator rod and separate diffuser, according to the prior art.

FIG. 9 illustrates the total brightness decay of a projector during a test of 2200 hours.

### DESCRIPTION OF EMBODIMENTS

### Definitions

“Wavelength conversion”: is a process in which a short wavelength excitation light, for example blue or near-UV laser light, can be converted into light with longer wavelength, for example green, yellow, or red light. There are materials, such as e.g., phosphor, that can emit longer wavelengths than it is illuminated with. For example, it can be illuminated with blue light and emit green or red light. Thus, by utilizing e.g., a red laser diode array and a blue laser diode array, together with at least one conversion material, e.g. phosphor, a light source comprising red, green and blue colors can be obtained. The conversion material could be based on e.g., phosphor materials. Quantum dots can also be used for wavelength conversion. To facilitate operation, the conversion material, e.g. phosphor, can be put on a wheel that can rotate, this is often referred to as a wavelength conversion wheel.

In the field of projection and the case where a single wavelength conversion material is used, the generated light can be further filtered and split up in primary colors. This can also be implemented by mounting the filter on a rotating wheel and hence often referred to as a filter wheel. If several wavelength conversion materials are used, a filter wheel can still be used to further filter out the unwanted bandwidths.

The following terms: “light rod” or “integrator rod”, “homogenizing rod”, or “light pipe” are used interchangeably throughout the specification. When the light rod comprises at least one diffusing surface, it can be referred to as “diffuser rod”.

### Description

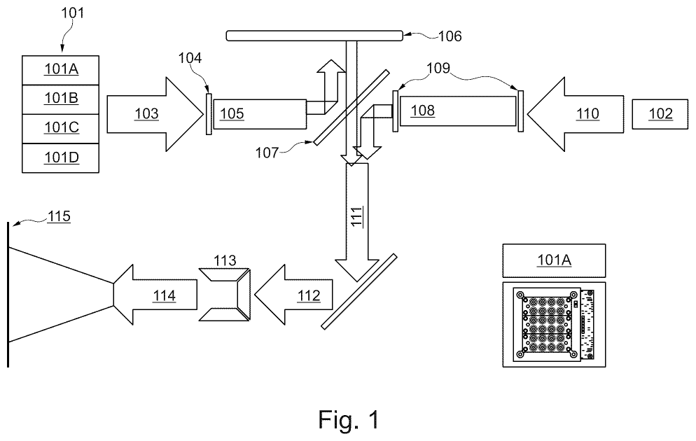

FIG. 1 illustrates a 3 chip DLP projector comprising two light sources 101A, 101B, 101C, 101D and 102. A first light source 101 comprising a plurality of laser clusters 101A-101D is configured to excite a wavelength conversion element 106. Collimating optics 103 is provided after the light source 101, before the light beam impinges on a static diffuser 103 provided before an integrator rod 105. A dichroic filter 107 is then configured to reflect the blue light emitted by the laser clusters, and transmit the light reflected by the phosphor 106, having greater wavelengths. The diffuser distributes the laser light across a wider range of angles such that a better homogenization takes place in the integrator rod 105. Speckle reduction benefit in this area is miniscule when considering the conversion efficiency, but is not a subject for the final image, as any speckle is eliminated by the wavelength conversion element, when photochemically converted.

A second beam, emitted by a second light source 102 (for example a laser cluster), after collimating optics 110, enters beam homogenization optics comprising an integrator rod 108 and two diffusers 109, upstream and downstream of the integrator rod 108. The light beam is then reflected by the dichroic filter 107 and combined to the first beam. Both beams enter then collimating optics 111 and relay optics 112, before modulation by the DLPs 113 for example. Imaging optics 114 projects the final image on a screen 115.

As described above, the diffusers are important to shape the light distribution in angular and positional space onto the phosphor. It is also important to reduce the peak intensity in lenses, and thereby avoid lens cracking. In addition, high laser power causes brightness decay, also due to aging of the coatings in the optical elements. Such ageing is increased by unwanted internal reflections/absorption. This decay should be kept to a minimum.

To that effect, if it is desirable to provide beam homogenization optics, which comprises at least a diffuser and a light rod. For example, it is desirable to diffuse the light beam with a first static diffuser, then integrate/randomize with the integration rod (or light rod), then diffuse again with a second static diffuser. This is the best-known solution today.

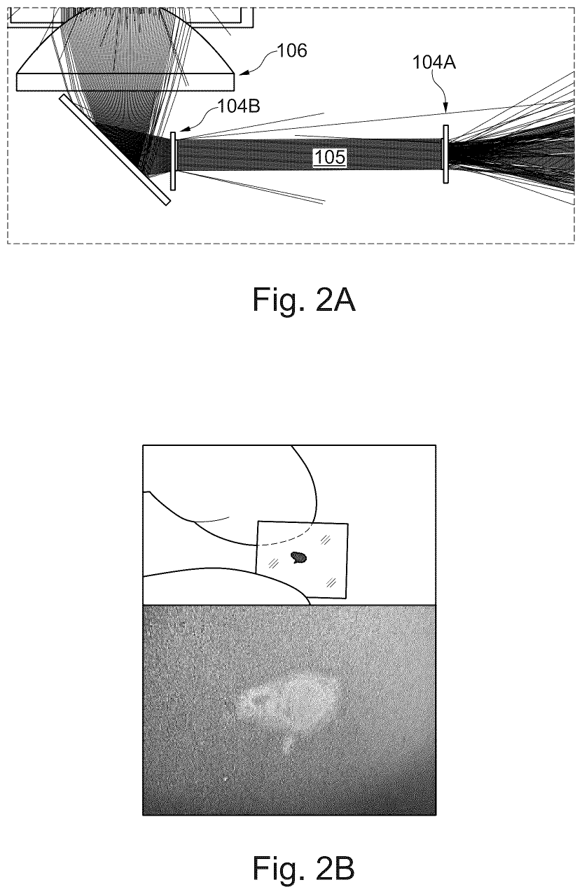

However, as illustrated in FIG. 2A, providing two diffusers 104A and 104B to solve the above problems on both ends of the light rod 105 provides additional problems.

In fact, each diffuser 104A, 104B has two surfaces, one flat and one with a diffusion grade. Both sides of the diffuser are coated with an anti-reflection (AR) coating. In addition, both sides of the light rod 105 are also flat and coated with anti-reflection coating. Each of these three optical elements requires an interface and fasteners. In addition, an airgap of at least 0.5 mm between the diffusers 104A, 104B and the light rod 105 is required for assembly and to avoid scratching the optical surfaces.

In addition, such a light rod 105 brings two additional surfaces to the optical design. As known by the skilled person, light that interacts with any material will either Reflect, Transmit, or be Absorbed. These three factors depend on material, wavelength, and surface morphology. Even the best of optical coatings do not have 100% transmission or reflection.

The accumulation of 6 surfaces with anti-reflection coatings results in a loss of 4.2% to 6%, by 0.7% to 1% on each surface due to internal reflections and absorption. This also increases with aging of the surfaces. Unwanted reflections result in rays lost and which increases damages of the optical surfaces. FIG. 2B illustrates an example of coating decay on a diffuser 104B.

The strength of the diffusers is an important parameter to consider in an optical design. As diffusers with different strengths are widely available in most optical catalogues, such optical diffusers are easy to implement, and be tested with different diffusing strengths.

It is pertinent to note that an enhanced angular smoothening directly on the phosphor does not need to be taken into account. Instead, the primary focus lies in achieving the utmost spatial homogenization. However, the angular smoothening facilitated by the diffuser positioned at the exit of the rod proves advantageous for safeguarding the integrity of intermediary optical components, including lenses, situated between the exit of the light rod and the phosphor wheel (serving as conjugate image planes). This preventive measure is particularly crucial to avoid issues such as cracking in these optical elements.

The inventors have imagined providing a diffuser on at least one of the surfaces of the light or integrator rod, which results in a diffuser rod. The results obtained with such a solution were beyond the expected results, as further explained below.

It is hereby provided an optical assembly for homogenizing the light beam and optimizing the wavelength conversion efficiency of an illumination system, the optical assembly being configured to be positioned in a beam path of the illumination system comprising a light source. The optical assembly comprises
a wavelength conversion element or a sensor such as a MEMS device,
a lens assembly comprising at least one lens for focusing the light beam on the wavelength conversion element,
an integrator rod comprising an entrance and an exit plane, wherein the exit plane of the integrator rod is configured to be reimaged on the wavelength conversion element via the lens assembly.
   wherein the surface of the exit plane of the integrator rod is a diffusing surface with an engineered topology optimized for the illumination system and reduced thermal saturation and quenching limits.

The light source of such an illumination system can be provided by
a first laser emitting a light beam and a first focusing lens assembly for focusing the light beam emitted by the first laser, or
a plurality of laser diodes, for example arranged in a cluster

Throughout this specification, the newly introduced term diffuser rod refers to a light rod or integrator rod having at least one surface with an engineered topology for controlled diffusing power in the illumination system. In the near field, a diffuser primarily performs angular reshaping. Spatial homogenization is effectively achieved when the diffuser is appropriately positioned along the optical path. For instance, placing a diffuser at the entrance of a light pipe enhances spatial homogenization at the light pipe's exit, thereby improving the spatial distribution on the subsequently optically relayed/imaged phosphor wheel/plate.

However, a diffuser positioned precisely at the exit of the light rod does not induce spatial homogenization when this exit is directly imaged onto the phosphor wheel/plate, as it entails a 1:1 imaging scenario. Instead, the role of this diffuser is exclusively to enhance the spatial distribution on components situated between these two conjugate image locations. This underscores the necessity for the diffuser to be precisely positioned at the exit interface for optimal performance.

Spatial homogenization involves equalizing the illuminance or power density across all dimensions of a beam within a specific plane, aiming for uniformity.

Angular homogenization, which is the main purpose of the present invention, focuses on achieving uniform luminous intensity, luminance, radiant intensity, or radiance throughout the maximum angular dimensions of an emission profile.

Angular smoothening is a process designed to mitigate peaks in luminous intensity, luminance, radiant intensity, or radiance within the angular emission profile of a beam departing from a designated plane.

The present invention aims at improving the angular homogenization and angular smoothing of the light beam propagation in the projection system.

Angular smoothening, as discussed earlier, indirectly contributes to the efficiency of wavelength conversion. The phosphor, acting as the wavelength converter, doesn't inherently perform better when illuminated from multiple angles. Its optimal functioning is tied to the homogeneity of spatial distribution, a criterion already fulfilled by the diffuser at the light rod's entrance. The phosphor thrives in an environment without spatial power density peaks, as they can lead to undesirable effects like quenching. However, angular variations do not pose a concern for the phosphor.

The real benefit of angular smoothening lies in enhancing the performance of optical components situated between the exit light rod and the phosphor-such as relay lenses. By allowing the beam to spread more evenly over angles from the light rod's exit, these components receive better-distributed illumination, reducing the likelihood of cracking. This improved distribution ensures prolonged component lifetime, potentially boosting overall efficiency by minimizing light absorption in cracks and similar issues.

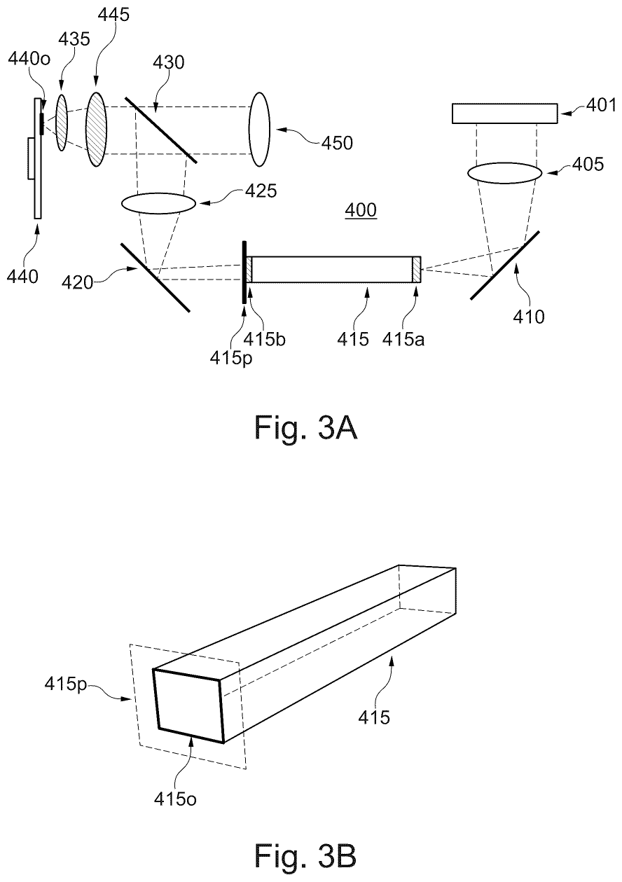

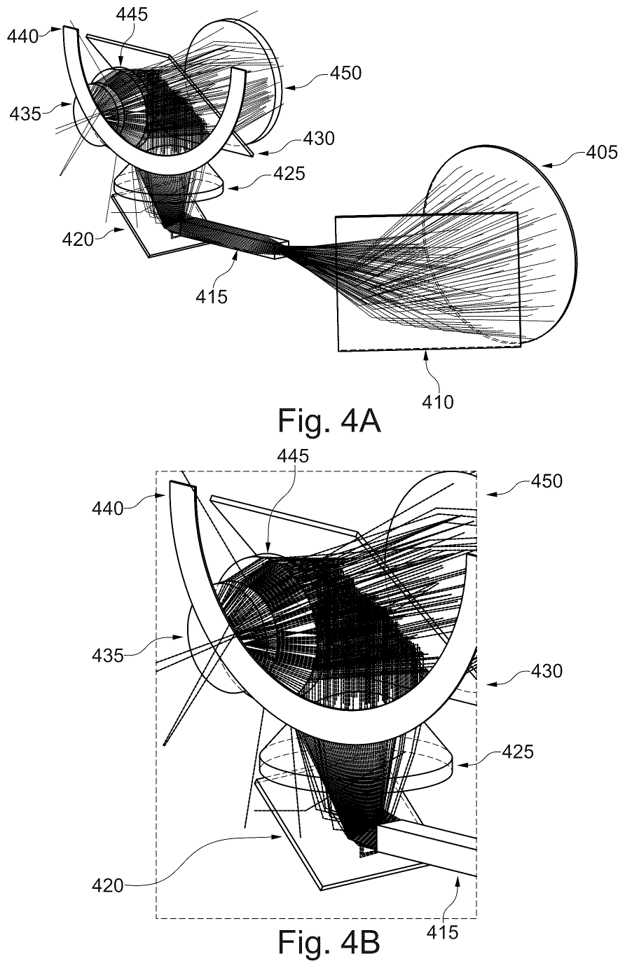

FIGS. 3A and 4A illustrate an exemplary schematic optical diagram of an illumination system 400, the illumination system being a laser/phosphor projector comprising a diffuser rod 415 according to the invention. It shows the relevant parts of the phosphor path in the illuminating optics of a laser/phosphor-based projector. A laser cluster 401 emits a light beam. A laser focusing lens 405 focuses the laser beam onto a diffuser rod 415 after reflection by a folding mirror 410, which is optional. The laser beam is preferably focused on the entrance surface of the diffuser rod, as will be explained later. After the diffuser rod 415, the lens assembly (425, 435) focuses the laser beam on the wavelength conversion element 440. After the diffuser rod 415, the laser beam can be reflected by a second folding mirror 420 and enters beam shaping optics element 425 before impinging on the dichroic filter 430. The dichroic filter 430 is configured to reflect blue light and transmit from cyan through the red range of the visual spectrum. The reflected blue light impinges then on the laser focusing length 435, is reflected by the wavelength conversion element 440. The beam reflected by the wavelength conversion element is substantially a converted beam. The converted beam is collimated by means of collimating lens 445 and is then transmitted by the dichroic filter 430 towards the remaining components of the projector. Lens 450 is then configured to collect the phosphor light beam and direct blue light and transmit it towards the rest of the system.

The diffuser rod 415 can have the following features. The diffuser rod can have the form of a longitudinal prism, or a light pipe, that utilizes total internal reflection (TIR) to transmit non-collimated light from the entrance to the exit of the light pipe. The entrance 415a and/or exit faces 415b preferably comprise an Anti-reflective (AR) coating. The cross-section profile of the light pipe can be any one of a polygon shape, such as a hexagonal shape, or circular shape, however a rectangular shape is typically the most cost-efficient solution. For any light pipe, the uniformity achieved at the output is proportional to the number of reflections along the length of the light pipe, controlled by its size, shape and length. Therefore, providing a cross-section which is the least regular may result in a light pipe with reduced length for achieving a similar effect. However, it is more difficult to manufacture a light pipe with a more complex cross-section.

As illustrated in FIGS. 3A, 3B, 4A and 4B, the diffuser rod 415 comprises an entrance plane 415a and an exit plane 415b, wherein the exit plane is an object plane 4150 of the projector. In fact, the collimating lens 425 and the second focusing lens assembly 435 are configured to focus an image of the object plane on the wavelength conversion element 440. Therefore, the exit plane 415b of the diffuser rod 415 is both an aperture stop (illustrated FIG. 3B with the black line 4150), which is also exactly in the object plane 415p of the illumination system 400. The frame is determined by the diffuser rod dimensions. Plane 415p illustrates the object plane in which lies the exit surface of the diffuser rod.

In addition, the surface of the exit plane 415b of the integrator rod is a diffusing surface with an optimized profile and surface morphology, depending on the source profile, and the desired output image.

The optimized profile required on the diffuser surface of the diffuser rod will be explained further.

Providing the diffuser directly on the exit surface and preferably as well on the entrance surface of the diffuser rod has the following advantages.

The following functions of optionally diffusing at the entrance (optional first diffuser on entrance surface), randomizing, and diffusing at the exit, are all provided by a single optical component. Both surfaces of the diffuser rod, of which at least one has a diffuser, are AR coated. Optionally, only one interface and fastener is required for the diffuser rod, for example along the center of the diffuser rod, instead of three as in prior art solutions.

In addition, since the diffuser surface(s) is (are) provided by a thicker optical element, the thermal benefits are increased, since there is more mass to absorb thermal gradients near the surface of the optical element. In fact, the length of the diffuser rod is significantly longer than the thickness of a simple diffuser.

There is only one surface comprising unwanted reflections/absorptions at each end of the light rod, which results in no rays being lost due to an airgap.

In addition, as there is no airgap and only one optical component to mount, the assembly is simpler, and the risk of scratching optical components is reduced.

Preferably, the diffusing surface of the diffuser rod has an optimized profile and surface morphology, depending on the source/input profile, and the desired output image.

An example of a diffuser profile is a profile with a HWHM (half width half maximum) in the range of 0.5° to 8°, preferably 1° to 6°, more preferably 2° to 4°, even more preferably 3°. However, these characteristics are of course system dependent. An example of a diffuser rod application is a gaussian profile on the entrance and exit planes of 3° HWHM. Given the same rod height, width and length, the resulting beam profile at the exit of the diffuser rod is equivalent to a 4.5° HWHM, which is equivalent to provide in the state-of the-art corresponding application a single diffuser as a separate part with a 4.5° HWHM.

In practice, the optimal HWHM is determined through a weighted consideration comprising at least one of the following factors:
a) Phosphor spot peak irradiance, tailored to a specified phosphor wheel size and optimal cooling conditions, ensuring it remains maximized while staying below the phosphor saturation/quenching limit.
b) Total power retained through relay optics and directed onto the phosphor, optimized to achieve the highest level possible without surpassing the phosphor saturation/quenching limit.
c) Peak irradiance at the core of the weakest lens in the system downstream of the diffuser rod, minimized to the lowest achievable level.
d) Total resulting brightness output downstream of lens (450), optimized to attain the highest level possible. In addition, as the diffuser rod according to the invention achieves a higher quantity of reflections than a state-of-the-art light rod, and thus better uniformity, the length of the diffuser rod can be shortened for a similar effect, which will benefit compactness at system level.

In addition, providing the diffusers on at least one of the entrance or exit surfaces has the advantage to further reduce the number of optical surfaces in the optical design.

As it is the exit surface of the diffuser rod which is reimaged on the surface of the wavelength conversion element, the image of the exit surface is not defocused.

The diffuser rod can also have a tapered shape to reduce the angle distribution spread, but without reducing the quantity of internal reflections.

As explained above, the optical properties or design variables of the diffuser rod will depend on the optical design of the illumination system. The following design variables of the diffuser rod are all design-dependent and can be calculated for optimal performance in a given optical system:
Length of the diffuser rod,
dimensions and shape of the cross-section of the diffuser rod,
refractive index of material used,
profile of the diffuser,
grade and topography of the diffused faces.

For the incoming light: the variable input data comprises the ray bundles angle distribution, power distribution in the image plane of the entrance of the diffuser rod, and the wavelength(s) of the light rays.

For the outgoing light: the variable output data comprises the desired angle distribution at the output of the diffuser rod (higher total angle than for input, caused by the diffusion) and the desired power distribution, or uniformity.

The shape of the integrator rod (cross section dimensions and shape) and the length of the integrator rod can be selected by considering various criteria. The longer the integrator rod, the more reflections there will be. The largest the entrance, the more light it will collect, but the rays will be less integrated. The output intensity will be higher with a smaller rod, etc. The shape and length can thus be selected by taking into account the amount of light it should capture at the entrance, the number of reflections that are required along the length of the integrator rod to achieve the desired output power, and the desired angle distributions which is also determined by the diffuser profile at the entrance, all parameters which determine the intensity, scale and uniformity of the output image.

These design and system-dependent variables mentioned above are typically calculated (or optimized) using algorithms Levenberg-Marquardt/Damped-least-squares, and/or Orthogonal descent.

To achieve the desired focus distance and size of the image from the diffuser rod exit surface towards the target object plane (i.e., top surface of a wavelength conversion element 440), a lens assembly 425, 435 comprising at least one lens between the exit surface 415b of the diffuser rod 415, which coincides with the object plane 415p, and target object 440o on the wavelength conversion element 440, are typically used.

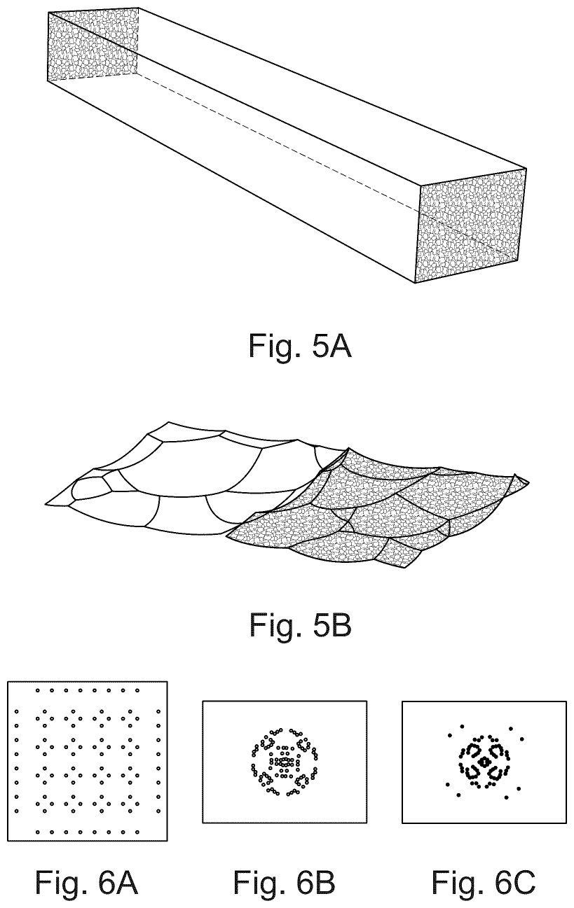

FIG. 5A illustrates a diffuser rod according to the present invention. In this example, both surfaces of the diffuser rod are diffusing surfaces. In FIG. 5B, an example of topology of the diffusing surfaces is illustrated. To achieve such a topology, the surfaces can be glass blasted with a gaussian profile. Diffusion can be obtained by different methods and profiles. The topology can also be engineered to a customized, specific shape, but tool-reliant options can be very expensive at the moment.

The lateral sides of the diffuser rod are preferably uncoated, and polished. These later sides need to provide internal reflections to the light beam traversing the diffuser rod.

The dimensions of the diffuser rod, i.e. the length, cross section shape and dimensions, determine the optimal randomization and angle distribution of rays for a uniform exit image. For a parallelepiped rectangular light pipe, the cross section is determined by its height and width, etc.

The index of refraction of the selected material is an important criterion for optimizing the optical system. In addition, an anti-reflection coating is preferably provided on each of the entrance and exit surfaces of the diffuser rod.

The desired profile of the diffusion is defined by the full or Half-width of half-maximum distribution.

The results obtained with the diffuser rod according to the present invention in a laser/phosphor projector were more than those expected. The improvements obtained with the diffuser rod are shown at each step along the optical path of the example of FIG. 4.

A distinction needs to be made between the terms “roughened” in the context of exit surfaces (which refers to a surface that has undergone a texturing process), and an intentionally designed topology with an optimized profile. The key difference lies in the intent to achieve the least possible micro-roughness, which would lead to the preference for an engineered or molded surface if cost were not a limiting factor. However, considering cost constraints, the more commonly employed option is the glass-blasted type, characterized by roughness around the peaks of the surface form, as illustrated in FIG. 5B.

In the prior art, the purpose appears usually to be steering clear of a non-diffuse surface, which could be a distinct part of a diffusion device. This precaution is taken to prevent unwanted reflections that could contribute to speckle.

It is undesirable for the microstructure of the diffusing feature to exhibit microscopic roughness, notwithstanding the inadvertent occurrence of such effects in certain manufacturing processes. Multiple recognized mechanisms for coating and substrate damage stem from unintended ionization or absorption. The objective is the redirection of rays, preferably excluding the effects of slowing down, scattering, or absorption.

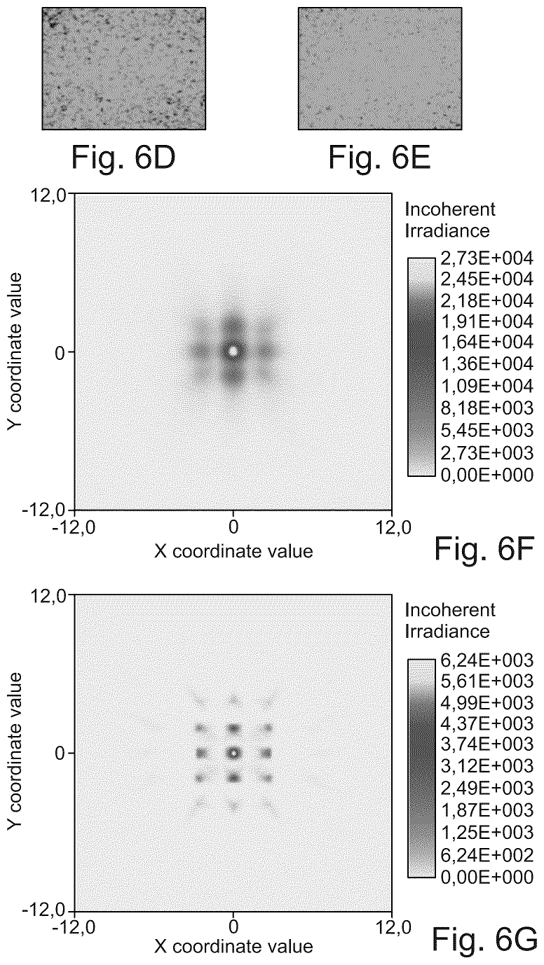

FIG. 6A illustrates the power distribution in the mid lens plane of the laser focusing lens 405. Considering the total initial power is 100%, the power in the mid lens plane drops down to 99.3%. One dot in the diagram corresponds to 5 W of power.

The remaining power in a plane upstream of the first diffusing surface of the diffuser rod has been measured to be 98.6%. The distribution is illustrated in FIG. 6B.

The remaining power in a plane located 1 mm inside the diffuser rod 415, downstream of the first entrance diffusing surface, has been measured to be 97.9% (FIG. 6C), whereas the solution with separate diffusers has been measured to provide a remaining power of 95.1%. This results already in a gain of 2.85%.

The power distribution in a plane 1 mm inside the diffuser rod, near and upstream of the exit plane has been measured to be 97.9%. With separate diffusers, the measured power distribution is 95.11%; which results in a gain of 2.85%. This is illustrated in FIG. 6D.

In a plane 1 mm downstream of the exit surface of the diffuser rod, the peak density has been measured to be 100 times better with the diffuser rod, with a nearly even angular spread.

FIG. 6E illustrates the power distribution in a plane 1 mm downstream of the exit diffusing surface to be 97.2% of the initial power, compared to 93.71% of the initial power for the solution without the diffuser rod.

Downstream of the diffuser rod, the aim of the optical design is to transport the light with minimal loss, and re-image the exit 415b of the diffuser rod onto the wavelength conversion element 440, at optimal scaling, with minimal geometrical distortion and minimal de-focusing.

The tested total output difference with the same total diffusion grade:
A: Prior art solution with separate diffusion surface, the diffuser having a thickness of 0.7 mm with a HWHM of 4.5° diffusing power. A1: one diffuser/A2: two diffusers. The light rod has two flat surfaces. The distance between the diffuser(s) and the light rod is 0.5 mm (air gap).
B: Solution with a diffuser rod having two diffusing surfaces, each having 3° HWHM which results in a total of 4.5° diffusing power. The grade has also been measured and confirmed by the supplier.
Comparison A1/B:3% of brightness increase with the diffuser rod (B) with respect to one separate diffuser (A1).
Comparison A2/B:6% of brightness increase with the diffuser rod (B) with respect to two separate single diffusers (A2).

This improvement over prior art solutions comes from the spot being without defocusing and the improved thermal distribution on the wavelength conversion element.

As illustrated in FIG. 4B, after the diffuser rod 415, there are 9 optical surfaces, which comprise 8 transmissive surfaces and one reflective. Remaining power has been measured to be 90.9%, which is to be compared to the prior art solution with separate diffusers which accounts for 88.8%.

The focusing lens 435 becomes the limiting factor for extreme power density applications. In fact, lens cracks and coating failures (damages) have been observed. Additional benefits of the double diffuser light rod (or diffuser rod) is to provide strongly lowered power density in the lenses, and at the same time, a better optimization of the power distribution in a spot on the wavelength conversion element.

It's imperative to emphasize that the meticulous positioning of the diffusing feature precisely at the exit plane of the diffuser rod represents the exclusive means to attain a flawlessly focused image during its re-imaging onto the surface of the wavelength conversion element.

In addition, there is also a gain of physical space.

FIGS. 6F and 6G illustrate a comparison of the peak irradiance in the focusing lens 435 without (6F), and with (6G) the diffuser rod according to the present invention respectively.

The transition from FIG. 6F to FIG. 6G demonstrates the efficacy of angular smoothening within the inventive design. The local power load density peaks are markedly diminished by the inventive additional diffuser incorporated in this invention.

The peak irradiance in focusing lens 435 is substantially reduced by approximately 4.4 times with the implementation of the diffuser rod. In this example, it decreases from 27300 to 6200 W/cm². This not only effectively addresses the concern of lens cracks across a broad spectrum of systems and power loads but also extends the range of systems capable of utilizing high index glass, contributing to enhanced compactness.

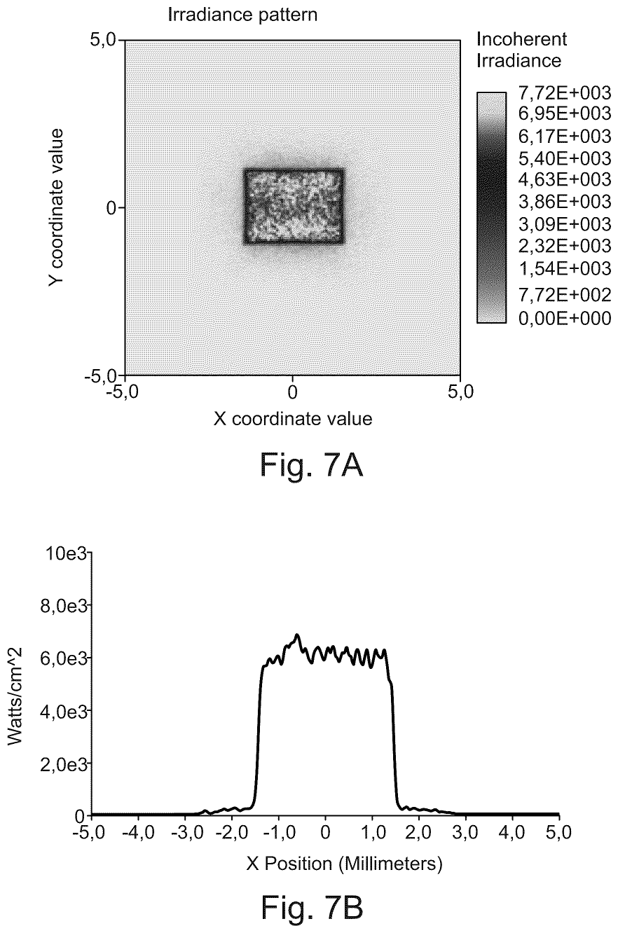

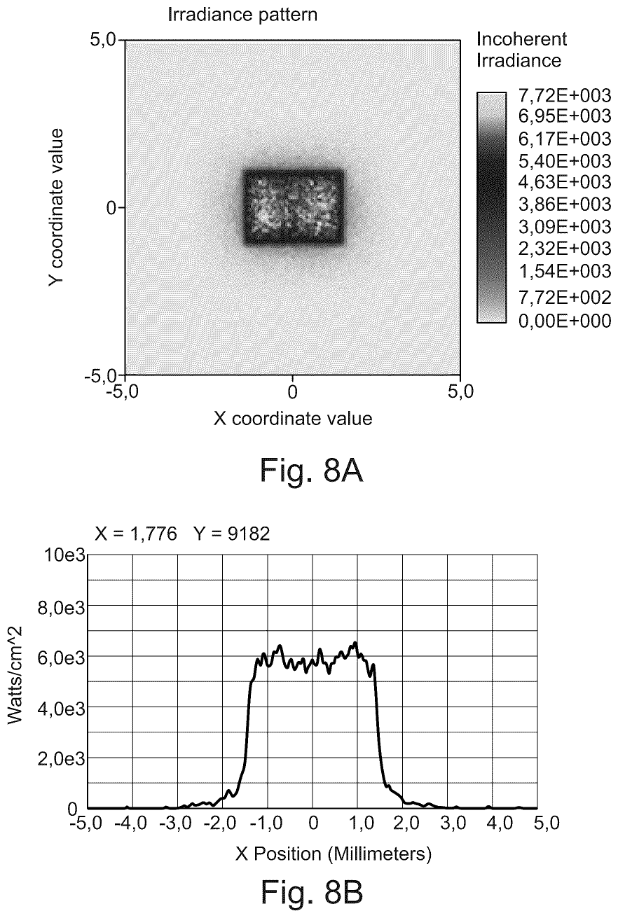

It can further be beneficial to compare the spot on the wavelength conversion element. In fact, FIGS. 7A, 7B, 8A and 8B illustrate the irradiance pattern on the wavelength conversion element, with the diffuser rod according to the invention and with an integrator rod and separate diffuser rod, according to the prior art. What is to be considered for the spot in this plane, is a spot having a distribution which is as uniform as possible, with the lowest possible amount of rays (and thus effect) outside of the main spot pattern, targeting a perfect, non-diffuse flat sided image (in this case a rectangle), as this spot image is to be re-imaged further into the system. Rays outside of this window will not be integrated/captured all the way through the complete system, and result in light losses.

This irradiance pattern of FIGS. 7A and 7B with the diffuser rod shows the following results and advantages over the state-of-the-art solutions:
Maximized input power compared to conventional diffusion method
Improved peak density in relation to conventional cooling methods
Improved spot uniformity, or flattened power distribution
No defocusing, as the diffusor is provided exactly in the image plane, which is not possible with prior art methods.

In FIGS. 8A and 8B, the irradiance pattern on the phosphor shows losses with the conventional method due to defocusing of the exit diffusor, which is not positioned in the image plane. The diffusor is positioned at the nearest possible position with respect to the image plane (0.5 mm+0.7 diffusor thickness), however this still results in unwanted defocusing. The intensity in the tails of the irradiance pattern is also important, comparing FIG. 8B and FIG. 7B. 3% more of the total light output is kept with diffuser rod, when considering the defocusing exclusively.

In addition, the present invention also provides thermal benefits which are far beyond the expected results.

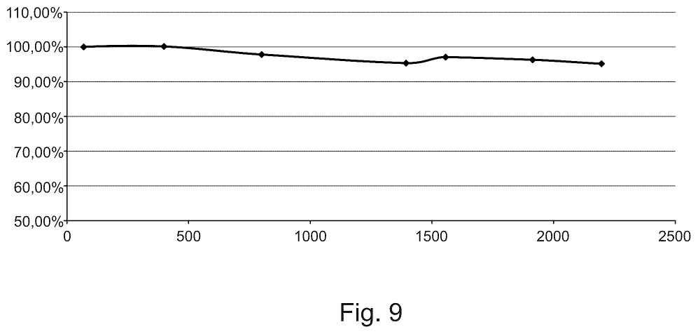

Thermal tests have been carried out with a diffuser rod in the optical path. In these tests, the diffuser rod has two diffusing surfaces. The thermal test has been run for 2200 hours and shows that the total brightness of the projector has only been reduced to 96% of the initial brightness, as illustrated in FIG. 9. The ageing of the anti-reflection coatings is improved. The anti-reflection coatings have not been damaged during these tests.

The thermal budget is drastically improved thanks to the heat dissipation inside the diffuser rod. In fact, since the diffusing surface is provided on a larger optical element (rod), the light rod is capable of absorbing the heat inside the rod, thereby preventing thermal peaks on optical surfaces such as on separate diffusers which have a limited thickness (0.7 mm for example), thereby protecting the coatings.

Such results have been proven with a simulation comparing the classical design with separate light rod and diffuser, and the diffuser rod according to the present invention.

Assuming each incident surface absorbs 0.5% of power, the following has been measured. With an incident optical power of 528 W, the thermal power is of 2.6 W.

The following parameters have been assumed in the simulation:
Conduction and radiation: Outer walls assumed to be 60° C.
Thermal contact resistance applied between glass and metal surfaces (“Milled aluminium, Ra 2.54 micron”).
“Glass, quartz” emissivity, other properties can be found in the following reference: www.matweb.com.

Simulation results show that the heat distribution in state-of-the-art solutions, i.e. on the separate diffusers reaches approximately 700° C., and nearly 600° C. on the light rod, whereas the heat distribution reaches only approximately 500° C. on the diffuser rod alone. Thus, the hot spot temperature is reduced by 200° C. Temperature differential vs. ambient is reduced by 28%.

The light rod maximal temperature is reduced by 40° C. by removing the radiative exchange with the diffuser. The peak temperature in the optical system is reduced by moving the diffuse surface from a separate glass element to the entrance of the solid rod.

This is explained by the lower thermal spreading resistance inside the solid diffuser rod (half-sphere) compared to the flat diffuser (quasi-flat plane with reduced thickness) and correspondingly larger heat transfer area.

The internal thermal gradient in the solid rod is lower than the thermal gradient in the diffuser, which could be beneficial in terms of thermal shock at start-up. In fact, an additional advantage of the present invention is provided at startup of the system. A thermal shock at start up may occur due to a rapid change in temperature within the projector. Such a thermal shock can strongly damage the coatings on various optical components within the projector. To avoid such a thermal shock, a possibility is to start the system progressively. Unfortunately, such a solution is often unwanted, as customers prefer the projector to be instantly on. The use of a diffuser rod as described in the present specification, provides additional advantages regarding the thermal shock at start up. In fact, within the diffuser rod the thermal shock is greatly reduced due to the mass and volume of the diffuser rod, in which heat can dissipate more quickly as in a separate diffuser which has a reduced thickness. The heat can dissipate at a certain depth within the diffuser rod, typically about a depth of 1 mm inside the diffuser rod.

Note: Natural convection may impact the actual temperature in the real application. Convection is not considered in this simulation, but the impact on the conclusions of this report (relative comparison) is considered small due to the small surface area and high absolute temperatures of the optical elements.

The degree of diffusion directly correlates with the damage threshold (LIDT (Laser-Induced Damage Threshold)) of a given surface, with smoother surfaces demonstrating increased resistance. The implementation of a diffuser rod facilitated a reduction in grading, indicating a smoother surface. This, combined with thermal advantages, contributed to an overall enhancement of the damage threshold. The method involves initial diffusion at the entrance, followed by additional homogenization in the light pipe, capitalizing on the variance in incident ray angles. Subsequently, exit diffusion, exclusively defocusing, alleviates stress on lenses, particularly advantageous with high index glass for compact designs. This approach not only mitigates the risk of cracking but also minimizes coating decay over the device's lifespan, ensuring the ray bundle returns precisely to focus at the wavelength conversion element. Opting to substitute the rod with a diffuser would necessitate a significantly higher grading, likely resulting in a suboptimal LIDT value and reduced efficiency in peak intensity reduction.

As explained throughout the specification, the diffuser has a surface with an engineered topology optimized for the illumination system and with reduced thermal saturation and quenching limits. This surface topology is strongly dependent on the optical design. It is known to the skilled person how to optimize an optical system having various parameters, in particular the topology of the diffuser(s) in the case of the present invention.

The following parameters of the optical assembly according to the present invention can be optimized for example by ray tracing:
Beam divergence, beam tilt,
Length, cross section or width and height of the integrator rod,
Tapered edges of the integrator rod,
Diffusion profile of the exit plane surface of the light rod,
Diffusion profile of the entrance plane surface of the light rod,
Position, diameter, focus, refractive index of the laser focusing lens,
Position, diameter, focus, refractive index of the collimating and focusing lens assembly.

The optimization can be carried out as follows:
1. All outer, maximal physical constraints are set as fixed in complete system design (given by space available within project requirements)
2. Maximum constraints for each optical element is roughly set to narrow the search range for the optimization algorithm, and maintain sensible cost and manufacturability.
3. Source tolerances: Beam tilt and divergence: variety within set limits are set to allowed in the system, in accordance with supplier's specifications.
4. All size and position related limits are allowed a range, given by the tolerances of single part, or surrounding/holding mechanics.
5. Optimization is set up by a ruleset, with the absolute most important target to have the lowest possible loss of rays from start to end of system. In a projector as described in the examples of the present specification, this target can be set to 90% (considering zero loss from the wavelength conversion element).-Needs to be below 100% to allow the optimization run to have flexibility. (Result after run was >95%, decidedly acceptable).
6. The optimization [reduction] algorithms used were both Levenberg-Marquardt/Damped-least-squares, and Orthogonal descent, running for 1-2 days each.

The present invention provides the following advantages:
The number of anti-reflective coated surfaces has been drastically reduced for the light to pass through, from 6 to 2, compared to prior art. In direct comparison, the gain is 3% increase in initial product brightness, considering single side diffusion, and 6% considering two-side diffusion (6%=initial 25000 lm product would be lifted to 26500 lm)
Each anti-reflective surface has a rate of decay through lifetime. With surface quantity reduced from 6 to 2, the decay rate of brightness level is reduced.
State of the art solution with a separate diffuser glass part next to a light pipe, needs to be placed with an airgap between the parts, for handling purpose, and to avoid scratching the parts against each other. The scattering caused by the diffuser parts result in 0.2% of rays not reaching the light pipe. The present invention does not have this loss and does not need an airgap in positioning.
Ease of assembly and handling. Prior art needs machined base for two extra diffuser parts, 2 extra glass parts, and 2 extra fastening clips.
Without the previously listed prior-art parts, a more compact design can be achieved.
The present invention allows for a system fold (a mirror to redirect the light) to be very close to entrance and exit, as there is no need for mechanical holder parts that would otherwise obstruct the light path.
Prior-art diffuser is typically of very thin material for efficient performance. (0.7 mm is typical). This is less than optimal for thermal properties, and the illuminated part can suffer coating deterioration partly relative to low heat transport. Present invention improves thermal properties by increased mass on the AR coated, diffused surface of the diffuser rod entrance and exit.
˜0.5% of the light between 6 surfaces of prior art is not transmitted, and instead absorbed or scattered/reflected backwards in the system. This is unwanted and reduced to ⅓ of the effect with the present invention.
Double-sided diffusion relieves later optics in the system very effectively and mitigates issues like lenses cracking due to high peak intensities.
The image from the light pipe exit is perfectly focused/re-imaged on the plane of the wavelength conversion element. This is not possible to achieve with prior art, there will always be a certain de-focusing. This defocusing is suboptimal for conversion efficiency.

While the invention has been described hereinabove with reference to specific embodiments, this was done to clarify and not to limit the invention. The skilled person will appreciate that various modifications and different combinations of disclosed features are possible without departing from the scope of the invention.

1. An optical assembly for homogenizing a light beam and optimizing the wavelength conversion efficiency of an illumination system, the optical assembly being configured to be positioned in a beam path of the illumination system comprising a light source emitting the light beam, the optical assembly comprising
a wavelength conversion element,
a lens assembly comprising at least one lens for focusing the light beam on the wavelength conversion element
an integrator rod comprising an entrance plane and an exit plane, wherein the exit plane of the integrator rod is configured to be reimaged on the wavelength conversion element via the lens assembly, wherein the surface of the exit plane of the integrator rod is a diffusing surface.

2. The optical assembly according to claim 1, wherein the diffusing surface is a surface having an engineered topology optimized for the illumination system and with reduced thermal saturation and quenching limits.

3. The optical assembly according to claim 1, wherein the surface of the entrance plane of the integrator rod is a diffusing surface having an engineered topology with an optimized profile and surface morphology.

4. The optical assembly according to claim 1, wherein the light source is provided by at least one of
a laser source emitting the light beam and a first focusing lens assembly for focusing the light beam, or
a plurality of laser diodes.

5. The optical assembly according to claim 1, wherein the integrator rod is a rectangular parallelepiped light pipe whose cross section at the exit plane is an aperture stop of the optical assembly.

6. The optical assembly according to claim 1, wherein the cross section of the integrator rod is a polygon, such as a hexagon, a pentagon, an octagon, or a trapezoid.

7. The optical assembly according to claim 1, wherein the edges of the integrator rod are tapered.

8. The optical assembly according to claim 1, wherein the diffuser profile is at least one of a Gaussian, Lambertian, top-hat engineered surface, and specific grading, such as a specific HWHM for a gaussian profile, and a specific grit (size of the grading).

9. The optical assembly according to claim 8, wherein the HWHM is determined through a weighted consideration comprising at least one of the following factors:
a) Phosphor spot peak irradiance, tailored to a specified phosphor wheel size and optimal cooling conditions, ensuring it remains maximized while staying below the phosphor saturation/quenching limit.
b) Total power retained through relay optics and directed onto the phosphor, optimized to achieve the highest level possible without surpassing the phosphor saturation/quenching limit.
c) Peak irradiance at the core of the weakest lens in the system downstream of the diffuser rod, minimized to the lowest achievable level.
d) Total resulting brightness output downstream of lens, optimized to attain the highest level possible.

10. The optical assembly according to claim 3, wherein the diffuser profile is the same on the entrance and exit planes of the integrator rod.

11. The optical assembly according to claim 3, wherein the diffuser profile is different on the entrance and exit planes of the integrator rod.

12. The optical assembly according to claim 3 wherein the surface of the exit plane and/or the entrance plane comprises an anti-reflection coating.

13. An illumination system comprising the optical assembly according to claim 1.

14. The illumination system according to claim 13 wherein the illumination system is a projector.

15. The illumination system according to claim 11 wherein the illumination system is a light canon.

16. The illumination system according to claim 14 wherein the light source is provided by at least one of
a laser source emitting the light beam and a first focusing lens assembly for focusing the light beam, or
a plurality of laser diodes.
